(19) United States
(12) Patent Application Publication
(10) Pub. No.: US 2007/0189362 A1
(43) Pub. Date: Aug. 16, 2007

(54) Method and system for channel estimation, related receiver and computer program product

(75) Inventors: Valeria D'Amico, Torino (IT); Bruno Melis, Torino (IT); Alfredo Ruscitto, Torino (IT)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: TELECOM ITALIA S.P.A., MILANO (IT)

(21) Appl. No.: 10/592,689

(22) PCT Filed: Mar. 24, 2004
(86) PCT No.: PCT/EP04/03114

§ 371 Date: Sep. 13, 2006

(51) Int. Cl. H04B 1/00

(52) U.S. Cl. 375/148

(57) ABSTRACT

A system for performing channel estimation based on a received signal including both known and unknown transmitted symbols, includes detector circuitry for detecting the unknown symbols by assigning estimated values to the unknown symbols, and channel estimator circuitry for performing channel estimation by exploiting both the known symbols and the estimated values assigned to the unknown symbols. The system has associated multiple receiving antennas. The system is preferably included in a CDMA receiver and the received signal includes known pilot bits and additional symbols, such as, transmit power-control commands, feedback information for transmitting antenna diversity, and a transport-format combination indicator that include the unknown symbols.

### FIELD OF THE INVENTION

The present invention relates to communication systems and was developed by paying specific attention to the possible application to receivers, such as e.g. receivers in radio base stations for mobile communication networks adapted to be equipped with multiple antennas.

Reference to this possible field of application of the invention is not however to be construed in a limiting sense of the scope thereof.

### DESCRIPTION OF THE RELATED ART

Multipath is a troublesome effect in many wireless communication systems. In addition to the signal originating from the direct path, other signals, originating from reflected paths, arrive at the receiver with different delays and attenuations. The main effects of multipath propagation are fading and intersymbol interference.

Diversity methods have been proposed for mitigating these unwanted effects.

One of the most efficient method exploits spread spectrum signals. By using a signal with a bandwidth much higher than the coherence bandwidth of the channel, it is possible to resolve the multipath components providing the receiver with different replicas of the transmitted signal.

The so-called “Rake” receiver is the conventional approach for optimum combining of spread spectrum signals. After having estimated the multipath structure of the channel, the received signal is passed through a Rake correlator that is matched to the transmitted waveforms. In that way, the temporal diversity of the multipath environment is exploited efficiently and the signal to noise ratio increased accordingly.

Spatial diversity using two receiving antennas separated enough for achieving low fading correlation is another technique used in wireless communication systems for reducing the effects of multipath fading.

The separation required depends on the angular spread, which is the angle over which the signal arrives at the receiving antennas. In the case of handsets (such as mobile phones), which are generally surrounded by scattering objects, the angular spread is typically wide and a quarter/half wavelength spacing of the antennas may be sufficient. This applies also for base station antennas in indoor systems.

For outdoor systems with high base station antennas, located above the clutter level, the angle spread may be only a few degrees and a horizontal separation of 10-20 wavelengths is required, making the antenna size at the base station a critical issue.

In a spread spectrum receiver employing multiple antennas, the received signal components are characterized both by spatial diversity and by temporal diversity. In the literature, the combination of temporally diverse signal components is referred to as “Rake” combining while the combination of spatially diverse components is referred to as antenna combining.

A more advanced solution with respect to conventional two-branch spatial diversity is an antenna array. The antenna array consists of M antenna elements, where the number M of antenna elements typically varies from 4 to 8 and the antenna separation can be, for example, half-wavelength (λ\2). The signals received from the M elements are weighted and recombined in order to maximize the received signal-to-noise ratio by means of a module denoted as beamforming unit.

The simplest receiver architecture is the so-called Switched Beam System (SBS). The SBS consists of a beamformer in the RF stage that forms multiple fixed beams (non-adaptive), a selector that determines the beam that has the best Signal to Interference Ratio (SIR) and a switch that is used to select the best (or the two best) beams. The best signal is then provided to a Rake receiver in order to exploit the temporal diversity offered by the multipath propagation.

A more sophisticated approach is adaptive space-time processing. The signals received from the M antennas are converted down to baseband and sampled. As a consequence, a space-time receiver requires M receiver front-end units that perform the radio frequency (RF) filtering to reject undesired signals (e.g. out of band interference), the signal amplification with a Low Noise Amplifier (LNA), a frequency down conversion to the intermediate frequency (IF), IF filtering, baseband down-conversion, analog to digital conversion (ADC) and baseband digital filtering. The block diagram of the receiver front-end in case of M=4 antennas (1 a 4) is shown in FIG. 1.

Specifically, in that figure, a plurality of receiver front-end channels is shown each including a RF/IF converter, an analog-to-digital (ADC) converter and a digital front-end (DFE) stage.

The M digital signals at the output of the receiver front-ends are then processed by a space-time processing unit (ST) in order to perform the temporal and the spatial combining. The soft symbols at the output of the space-time processing unit ST are then provided to the outer modem BBP that performs de-interleaving, rate matching and channel decoding operations providing the Medium Access Control (MAC) Layer with the correspondent Transport Channels (TrCH).

Different space-time processing architectures have been envisaged in the prior art based on the method adopted for the signal combining. A first space-time architecture, often denoted as 2D-Rake receiver, is shown in FIG. 2 for the case of M=4 antennas.

The 2D-Rake receiver consists of a plurality of beamforming units BU fed with the signals from the various receiver front-ends RFE associated with the various antenna receivers. The beamforming units BU are followed by a classical Rake receiver RR including a corresponding plurality of “fingers” F1, . . . , FN. Assuming that the different multipath components arrive simultaneously at the various antenna elements (i.e. narrowband array case), each beamforming unit BU performs spatial combining for a given multipath component.

The M=4 spatial weighting factors S₁, . . . , S₄ for the different antennas 1 to 4 are calculated independently in each beamforming unit (as shown in FIG. 3) by means of a proper module M whose purpose is to maximize the Signal to Interference Ratio (SIR) at the beamformer output or equivalently, in terms of radiation diagram, maximize the antenna array gain in correspondence of the Direction of Arrival (DoA) of the useful signal and minimize such gain on the DoA of the interfering signals. To that end, signals derived from the antennas (1 to 4), are fed, after RFE processing, to the respective despreader units D1 to D4 and then on to the module M.

The calculation of the spatial weighting coefficients is based on adaptive algorithms as for example the MMSE (Minimum Mean Square Error). A central problem of these algorithms is that they require knowledge or estimation of the desired spatial filter output. This is accomplished by periodically transmitting a training sequence, which is known to the receiver.

In Code Division Multiple Access (CDMA) systems, signal-to-interference ratio (SIR) before despreading is very low and thus the training sequence is first despread and then used for the calculation of the weighting coefficients. Therefore, each beamforming unit performs the despreading of the training sequence by using M despreading units, one for each antenna.

A 2D-Rake receiver is comprised of N beamformers, where N is the number of multipath components received. The number of despreading units to be implemented in the beamforming units is equal to M×N. After the calculation of the spatial weighting factors Sᵢ (1≦i≦M), these factors are used for weighting, at chip level, the signals received from the different antennas. Subsequently, the various signals are summed in an adder A and provided at the input of the Rake finger. The block diagram of one beamforming unit for the case of M=4 antennas is shown in FIG. 3.

After antenna combination the N multipath components are recombined by means of a classical Rake receiver using for example an MRC (Maximum Ratio Combining) criterion.

An improvement of the 2D-Rake architecture is obtained by considering space and time jointly. The idea of this architecture is derived from the concept of wideband array. A wideband array is an adaptive array system that combines spatial filtering with temporal filtering. In this type of system, illustrated in FIG. 4, a tapped delay line is used on each antenna 1 to 4 of the array.

The tapped delay line DL1, . . . , DL4 allows each antenna element to have a phase response that varies with frequency. This compensates for the fact that lower frequency signal components have less phase shift for a given propagation distance, while higher frequency signals components have greater phase shift as they travel for the same distance. This structure can be considered as an equalizer that makes the response of the array equal across different frequencies.

Even if the bandwidth of the signals incident on the array is very small related to the centre frequency, so that the bandwidth degradation is not a critical factor, the wideband array architecture can be extremely valuable.

In fact, it can be understood that the two dimensional structure is able to capture energy from multipath components arriving at significant different delays, combining features of both a spatial processor and a temporal equalizer (i.e. a Rake receiver). Instead of computing the spatial and the temporal weight vectors W_{i,j} in a sequential manner, one can compute them jointly, leading to a weight matrix of size M×N, where M is the number of antennas and N is the number of time resolvable multipath components. Unlike the 2D-Rake architecture, the joint calculation of the spatial and the temporal weight factors allows to exploit the correlation that may exist between the space and time dimension of the channel.

As previously discussed, the computation of the weighting factors can be based on a training sequence. Moreover, as both despreading and weighting are linear operations, the multiplication of the received signals for the weighting factors can be indifferently done at chip (before despreading) or symbol level (after despreading). In order to reduce the number of multiplications, and thus the hardware complexity, the second solution is preferred.

This second space-time architecture is shown in FIG. 5 for the case of M=4 antennas and N=2 multipath components. Again, in FIG. 5, the reference RFE designates the various receiver front-ends associated with the antennas 1 to 4, while BU and A denote the beamforming unit and the adder module, respectively.

Some of the concepts outlined in the foregoing are documented in the patent literature.

For instance, U.S. Pat. No. 6,320,899 discloses the structure of a 2D-Rake receiver suitable for spread spectrum receivers equipped with multiple receiving antennas.

U.S. Pat. No. 5,809,020 discloses a method for adaptively adjusting the weighting coefficients in a CDMA radio receiver equipped with two antennas. The pilot symbols received from the different antennas are first despread and then used for the computation of the weighting coefficients. The weighting coefficients are computed independently for each antenna using, for example, the LMS (Least Mean Squares) algorithm. The traffic data are despread and then weighted by the complex conjugate of the weighting coefficients.

EP-A-0 999 652 discloses a receiver architecture where the optimisation of the weighting coefficients for the temporal and spatial combining is performed jointly, leading to a single combining vector. A training sequence transmitted on a pilot signal is used in the beamforming unit for determining the rake combining vector.

Finally, WO 03/023988 discloses a method for combining spread spectrum signals in a receiver equipped with multiple antennas. The method comprises the steps of despreading the signal components and determining a set of weighting coefficients using a MMSE (Minimum Mean Square Error) method, which considers the space and the time variables of the signal components in parallel. The MMSE method is implemented using a generic stochastic gradient algorithm, such as the LMS, and exploits the known pilot signal as the training sequence.

The architectures previously described are applicable, for example, in case of the W-CDMA component of the UMTS system by exploiting the uplink pilot sequence as training sequence.

### OBJECT AND SUMMARY OF THE INVENTION

A common characteristic of the prior art considered in the foregoing is that computation of the weighting coefficients in the beamforming algorithm is based solely on known symbols, such as the pilot symbols.

However, because of the limited number of pilot symbols, performance of the beamforming algorithm degrades in the presence of multiple access interference and thermal noise.

The object of the present invention is to provide a solution dispensing with this possible source of degradation.

According to the present invention, that object is achieved by means of a method having the features set forth in the claims that follow. The invention also relates to a corresponding system and receiver, as well as to a computer program product loadable in the memory of at least one computer and comprising software code portions for performing the steps of the method of invention when the product is run on a computer. As used herein, reference to such a computer program product is intended to be equivalent to reference to a computer-readable medium containing instructions for controlling a computer system to coordinate the performance of the method of the invention. Reference to “at least one computer” is evidently intended to highlight the possibility for the system of the invention to be implemented in a distributed fashion.

Essentially, a preferred embodiment of the invention is a method of performing channel estimation based on a signal received after propagation over a communication channel, the received signal including both known and unknown symbols, the method including the steps of:

detecting the unknown symbols in the received signal by assigning estimated values to the unknown symbols, and

performing channel estimation by exploiting both the known symbols and the estimated values assigned to the unknown symbols, wherein the received signal is produced by using multiple receiving antennas, the multiple receiving antenna being for example diversity antennas.

The arrangement described herein is based on the recognition that the problems outlined in the foregoing can be solved by exploiting also other symbols, hereinafter referred to as additional symbols, for the training of the beamforming algorithm. As the additional symbols are not known at the receiver, the arrangement described herein provides for a fast and reliable detection of the additional symbols, introducing at the same time just a minor increase in the receiver complexity.

In the case of a W-CDMA system, symbols eligible for use as the additional symbols are the TPC (Transmit Power Control), TFCI (Transport Format Combination Indicator) and FBI (Feedback Information) bits transmitted on the uplink DPCCH channel.

In the exemplary arrangement described herein, such additional symbols are adopted to ensure reliable estimation and can be used for the training of the beamforming algorithm together with the known pilot bits. As indicated, the arrangement described herein entails just a minor increase in the complexity of the receiver while leading to quite a significant improvement of system performance.

A significant feature of the arrangement described herein is the exploitation of other symbols (e.g. control symbols, data symbols, etc.), in addition to the known symbols, for the computation of the weighting coefficients. Since the additional symbols are not known a priori by the receiver, a fast and reliable detection thereof is performed by introducing just a small increase in the receiver complexity. The improvement in terms of link performance is however quite significant if compared to the small amount of additional complexity.

### BRIEF DESCRIPTION OF THE ANNEXED DRAWINGS

The invention will now be described, by way of example only, by referring to the annexed figures of drawing, wherein:

FIGS. 1 to 5, representative of the prior art, have already been described previously,

FIG. 6 is exemplary of typical signal patterns in CDMA communications, and

FIGS. 7 to 11 are block diagrams representative of a preferred embodiment of the arrangement described herein.

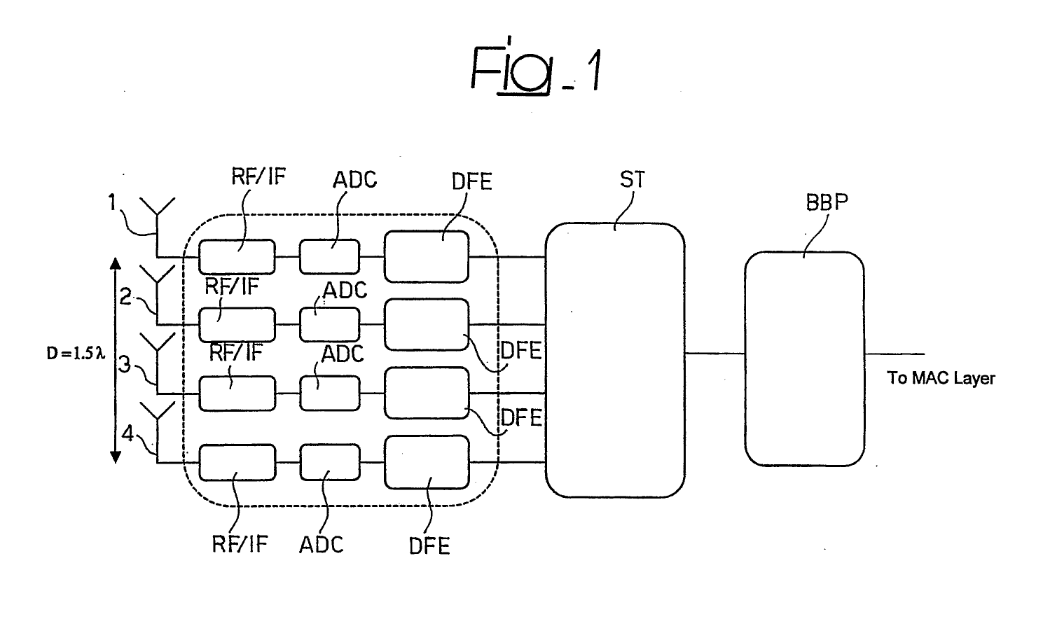

### DETAILED DESCRIPTION OF A PREFERRED EMBODIMENTS OF THE INVENTION

The present invention will now be described, by way of example only, by referring to the possible application in a W-CDMA system. Those of skill in the art will however promptly appreciate that the same basic arrangement described herein can be applied to other communication systems or standards.

As a first point, the structure of the uplink dedicated channels of the W-CDMA system will be briefly analysed: again, reference to this specific application is purely exemplary in its nature and is not to be construed in a limiting sense of the scope of the invention.

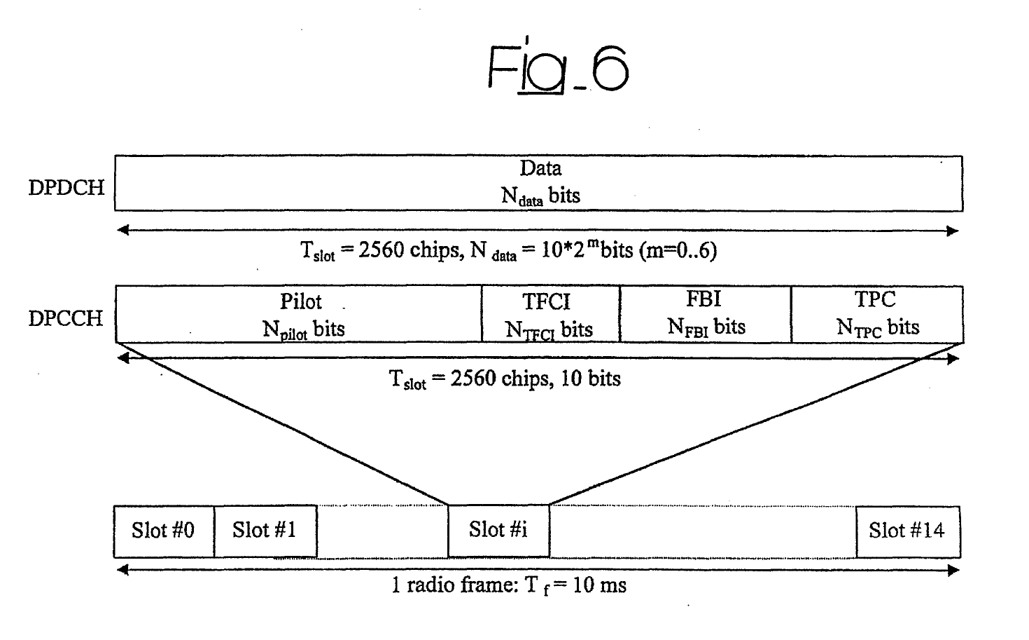

The frame structure of the W-CDMA “uplink” (i.e. from the mobile terminal to the radio base station) dedicated physical channels is shown in FIG. 6. Each radio frame of length 10 ms is split into 15 slots, each of length T_{SLOT}=2560 chips, corresponding to one power control period.

There are two types of uplink dedicated physical channels, the uplink Dedicated Physical Data Channel (uplink DPDCH) and the uplink Dedicated Physical Control Channel (uplink DPCCH). The DPDCH spreading factor may range from 256 down to 4. The spreading factor of the uplink DPCCH is always equal to 256, i.e. there are always 10 bits per uplink DPCCH slot.

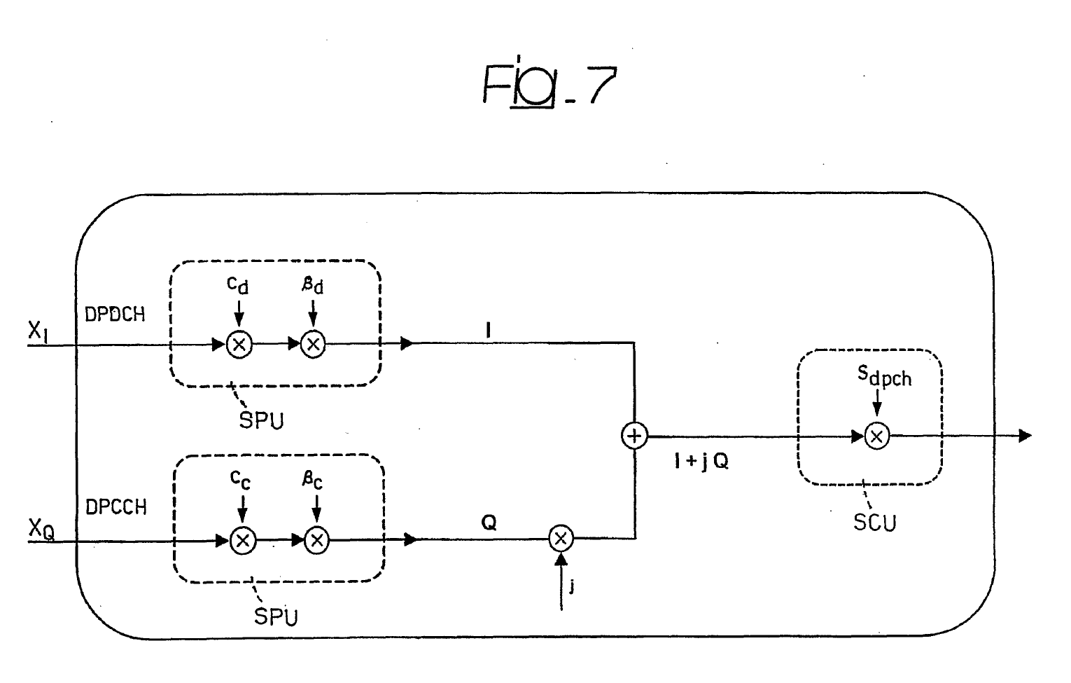

The flows of bits corresponding to the DPDCH and the DPCCH channels are multiplied respectively by the orthogonal variable spreading factor (OVSF) sequences c_{d} and c_{c} and then weighted by the gain factors, β_{d} for the DPDCH and β_{c} for the DPCCH. The data flows corresponding to the DPDCH and DPCCH, associated respectively to the I and Q phases of a QPSK modulation, are then scrambled with a complex scrambling code S_{dpch}. These operations are shown in FIG. 7, where references SPU and SCU designate spreading units and a scrambling unit, respectively.

The uplink DPDCH is used to carry the DCH transport channel. The uplink DPCCH is used to carry control information generated at Layer 1. The Layer 1 control information consists of:

known pilot bits to support channel estimation for coherent detection, and

transmit power-control (TPC) commands, feedback information (FBI) for transmitting antenna diversity in downlink and an optional transport-format combination indicator (TFCI).

The number of pilot bits (N_{PILOT}) depends on the selected transmission mode and ranges from a minimum of 3 pilot bits to a maximum of 8 bits.

The bit sequences transmitted on the pilot field change on a slot basis and are repeated in each frame. The receiving base station (in a practical embodiment, a Base Station) knows a priori only the pilot sequences, while the other DPCCH bits (TPC, FBI and TFCI) are “unknown” because they depend on the current transmission format and on the propagation conditions.

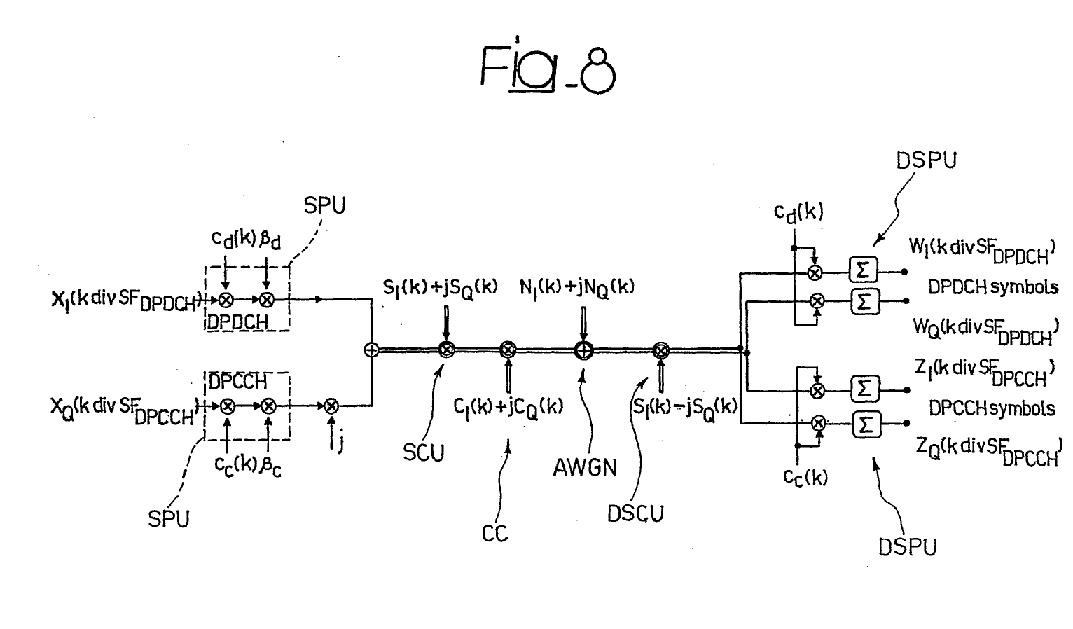

The equivalent baseband model of the dedicated channels in the uplink is shown in FIG. 8. In addition to the units SPU and SCU already introduced in FIG. 7, the diagram of FIG. 8 also portrays elements representative of transmission over a channel (channel coefficients CC and additive white Gaussian noise AWGN) as well as de-spreading units DSPU.

In order to introduce a mathematical model suitable for sequences with different rates, we denote with k the temporal index related to the chip period so that c_{d}(k)=c_{d}(k·T_{C}), where T_{C} is the chip period.

If SF_{DPDCH} denotes the spreading factor of the DPDCH, the period of the sequence transmitted on the DPDCH is equal to SF_{DPDCH}·T_{C} so that the temporal index related to the symbol period is equal to (k div SF_{DPDCH}), where A div B is the integer part of the quotient between A and B. By using the same approach the temporal index related to the symbol period of the DPCCH is equal to (k div SF_{DPCCH}).

In the transmitter, after the operation of spreading the complex signal X_{I} (k div SF_{DPDCH})·c_{d}(k)·β_{d}+j·X_{Q} (k div SF_{DPCCH})·c_{c} (k)·β_{c} is multiplied by the complex scrambling sequence S_{dpch}(k)=S_{I} (k)+j S_{Q} (k)

The goal of this operation is to introduce a 25 certain level of isolation between the signals of the different users of a cell. At the receiver side, the effect of the scrambling code is removed by multiplying the input sequence by the complex conjugate of the correspondent scrambling sequence. This operation as performed in the units designated DSCU is referred to as de-scrambling.

The effect of the fading channel on the received signal can be modeled by means of a multiplicative complex coefficient C(k)=C_{I} (k)+j C_{Q} (k). Finally we denote with N(k)=N_{I} (k)+j N_{Q} (k) a gaussian base-band process modeling the amount of interference and noise affecting the received symbols.

At the receiver, after the de-scrambling operation, the real and the imaginary components of the received signal are multiplied by the spreading codes c_{d}(k) and c_{c}(k) and then integrated over a symbol period. We denote with W(k div SF_{DPDCH})=W_{I}(k div SF_{DPDCH})+j W_{Q}(k div SF_{DPDCH}) the complex sequence obtained after the operations of de-spreading the received sequence with the code c_{d}(k) and integration over a symbol period. In the same way Z(k div SF_{DPCCH})=Z_{I}(k div SF_{DPCCH})+j Z_{Q}(k div SF_{DPCCH}) is the complex sequence obtained after the operations of de-spreading the received sequence with the code c_{c}(k) and integration over a symbol period.

Even if the transmitted information sequence corresponding to the DPDCH is made only by real symbols X_{I}(k div SF_{DPDCH}), because of the phase rotation introduced by the channel coefficients C(k)=C_{I}(k)+j·C_{Q}(k), the received sequence W(k div SF_{DPDCH}) is complex. The same consideration can be derived for the sequence corresponding to the DPCCH symbols. In the absence of interference the expression of the received DPDCH symbols W(k div SF_{DPDCH}) is given by

$$W ( k div {SF}_{DPDCH} ) = 2 \cdot {X}_{I} ( k div {SF}_{DPDCH} ) \cdot {β}_{d} \cdot [ {\sum }_{k = 1}^{{SF}_{DPDCH}} {C}_{I} ( k ) + j \cdot {\sum }_{k = 1}^{{SF}_{DPDCH}} {C}_{Q} ( k ) ] \qquad ( 1 )$$

The correspondent expression for the received DPCCH symbols Z(k div SF_{DPCCH}) is given by

$$Z ( k div {SF}_{DPCCH} ) = 2 \cdot j \cdot {X}_{Q} ( k div {SF}_{DPCCH} ) \cdot {β}_{c} \cdot [ {\sum }_{k = 1}^{{SF}_{DPCCH}} {C}_{I} ( k ) + j \cdot {\sum }_{k = 1}^{{SF}_{DPCCH}} {C}_{Q} ( k ) ] \qquad ( 2 )$$

If we assume that the period of the symbols X_{Q}(k div SF_{DPCCH}) transmitted on the DPCCH is smaller than the coherence time of the channel we can consider the effect of the fading channel on each received chip of a given DPCCH symbol as a multiplicative constant coefficient
C(k)=C_{I}(k)+j C_{Q}(k)=C(k div SF_{DPCCH})=C_{I}(k div SF_{DPCCH})+j C_{Q}(k div SF_{DPCCH}) (3)

In this particular case if we replace equation (3) in (2) we obtain
Z(k div SF_{DPCCH})=2·j·X_{Q}(k div SF_{DPCCH})·β_{c}SF_{DPCCH}·{C_{I}(k div SF_{DPCCH})+j·C_{Q}(k div SF_{DPCCH})} (4)

while if we replace equation (3) in (1) we obtain
W(k div SF_{DPDCH})=2·X_{I}(k div SF_{DPDCH})·β_{d}SF_{DPDCH}·{C_{I}(k div SF_{DPCCH})+j·C_{Q}(k div SF_{DPCCH})} (5)

The received symbols Z(k) are used for the estimation of the transmission channel characteristics in the following way. Let X_{Q} (i) with i=0, 1, 2, . . . , N_{PILOT}-1 denote the pilot symbols transmitted on the DPCCH during the length of a slot. These symbols are known to the receiver and therefore their effect on the received symbol Z(k) can be eliminated by multiplying the in-phase and in-quadrature component of Z(k) for the value of the pilot symbol X_{Q}(k). Because X_{Q}(k)·X_{Q}(k)=1 we obtain
Z(k div SF_{DPCCH})·X_{Q}(k div SF_{DPCCH})=2j·β_{c}·SF_{DPCCH}·{C_{I}(k div SF_{DPCCH})+j·C_{Q}(k div SF_{DPCCH})} (6)

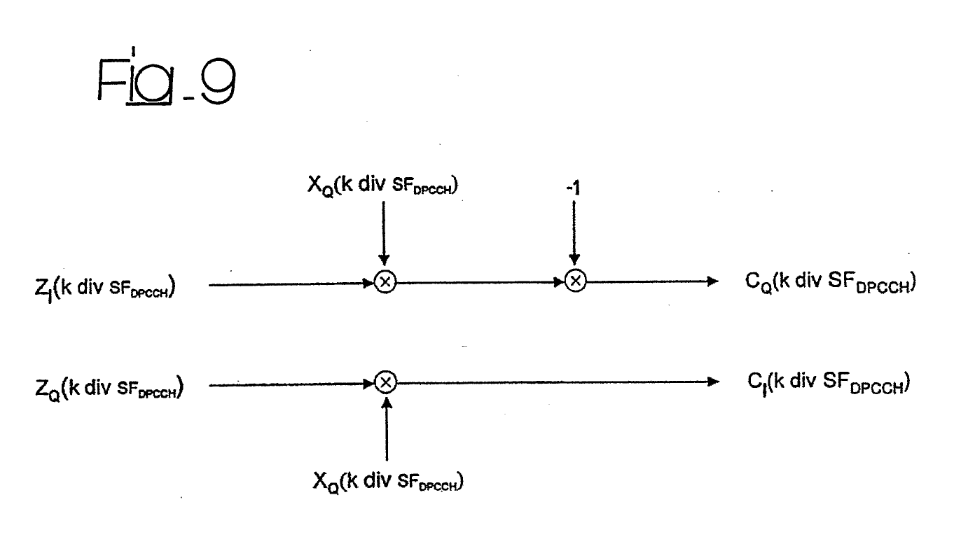

The in-phase component of the product Z(k div SF_{DPCCH}) X_{Q}(k div SF_{DPCCH}) is proportional to the opposite of the channel coefficient C_{Q}(k div SF_{DPCCH}) while the in-quadrature component is proportional to the channel coefficient C_{I}(k div SF_{DPCCH}). The circuit for the estimation of the channel coefficients is shown schematically in FIG. 9.

From FIG. 6 it is possible to conclude that the channel coefficients can be estimated in correspondence of the pilot symbols transmitted on the DPCCH. In fact the pilot symbols are transmitted only in the first part of every slot. The remaining part of the slot is used for the transmission of the TFCI, TPC and FBI bits so that it is not possible to estimate the channel coefficients continuously over one slot. In order to properly estimate the channel coefficients in the second part of every slot some kind of interpolation or prediction method is required. A possible solution that minimizes the complexity of the receiver is a linear interpolator operating between the last channel estimate obtained from the pilot symbol X_{Q}(N_{PILOT}-1) of the slot L and the first channel estimate obtained from the pilot symbol X_{Q}(0) of the slot L+1.

As explained in detail in the introductory portion of the description, prior-art beamforming algorithms exploit only the known symbols, such as pilot symbols, transmitted for channel estimation purposes.

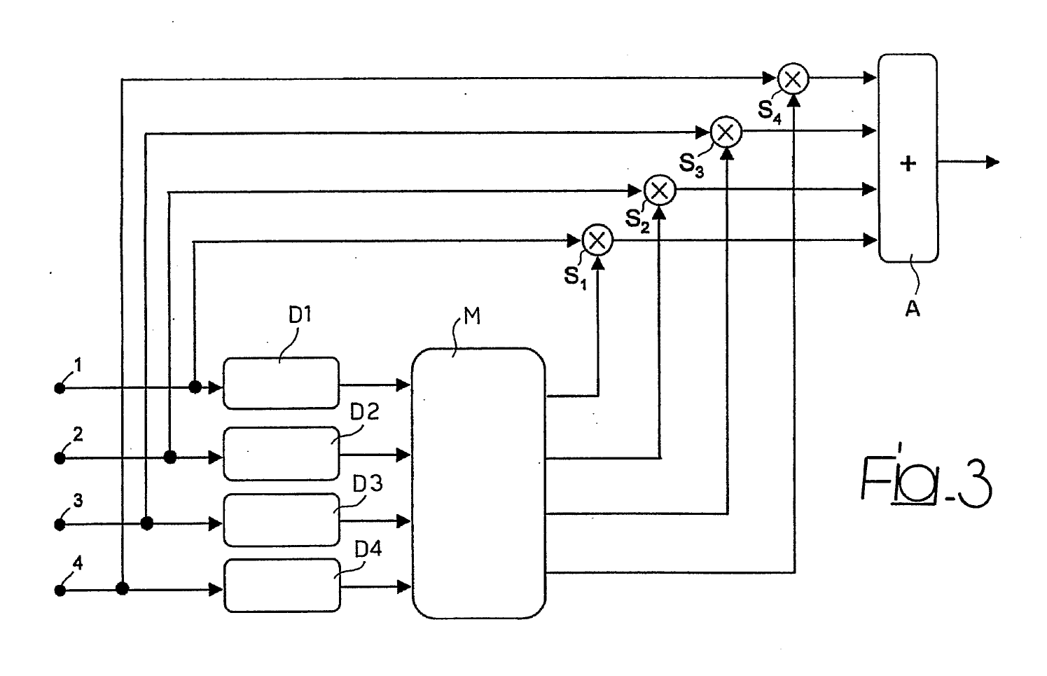

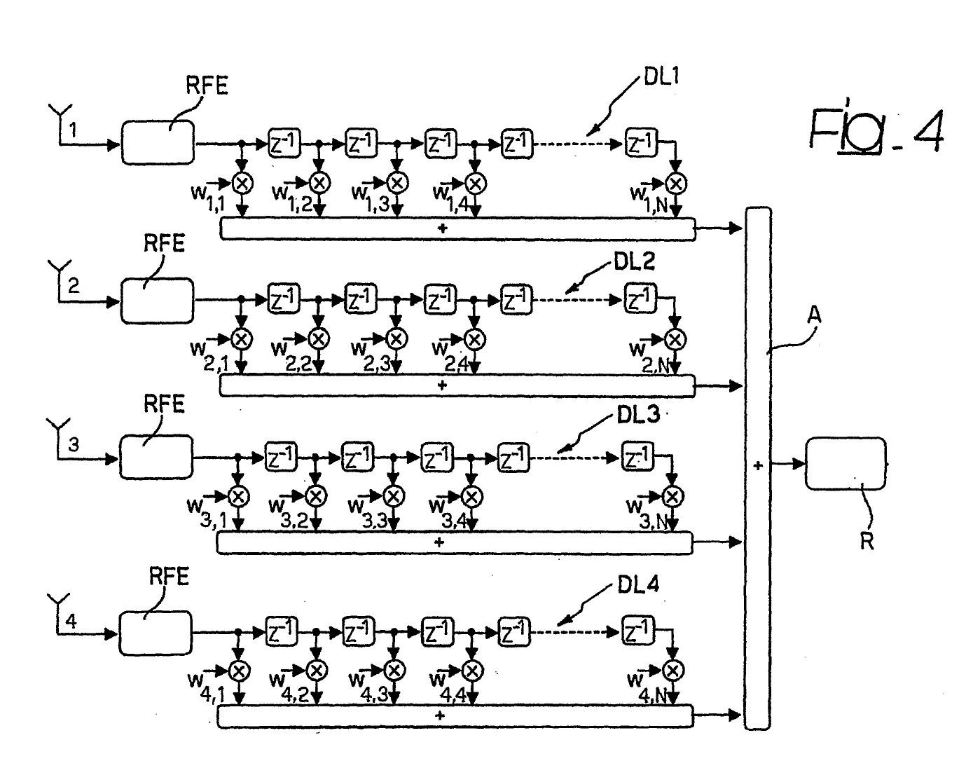

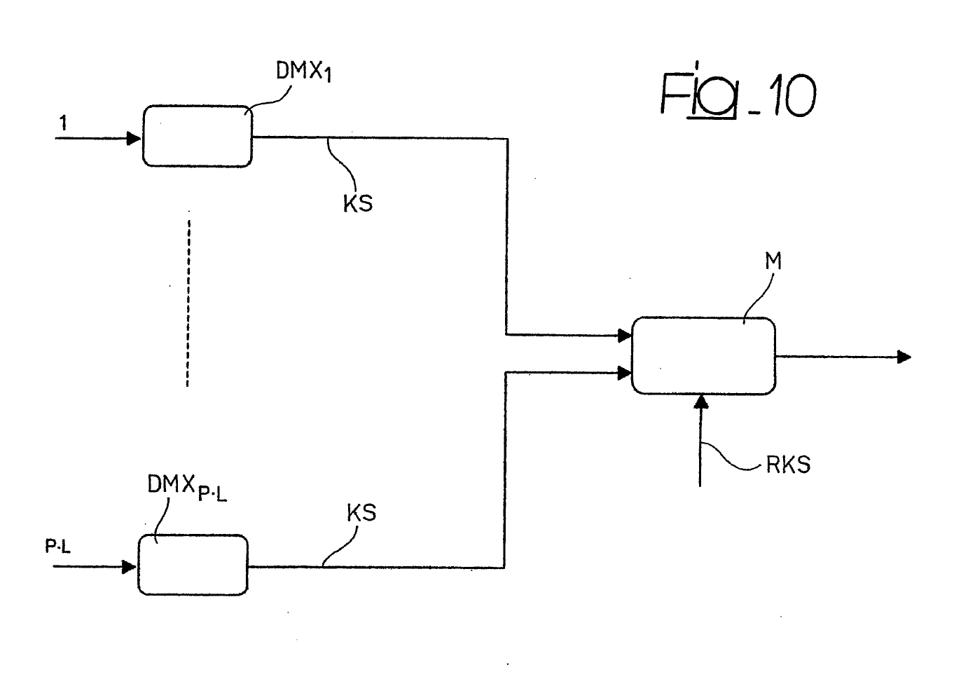

FIG. 10 shows the block diagram of a beamforming unit. This is, per se, as currently implemented in prior-art receivers. The received is comprised of P antennas (P≧2) and L Rake fingers for each antenna. The P·L Rake fingers perform the despreading of the received signal replicas. The de-spread known symbols at the output of the bank of P·L fingers are demultiplexed via demultiplexer DMX₁, . . . DMX_{P·L} and then provided to the unit M (see also FIG. 3) that computes the weighting coefficients. This unit receives also, as a second input, the known transmitted symbols RKS stored at the receiver that, being not affected by any channel distortion, noise or interference, are used as reference for the calculation of the weighting coefficients.

In prior art arrangements, only the symbols denoted KS, received in correspondence of the known transmitted symbols (the pilot bits in the case of W-CDMA system) are exploited for training the beamforming algorithm. In order to reduce the negative effect of thermal noise and interference, the symbols KS received in correspondence with the known transmitted symbols are processed by performing some kind of averaging. The number (N_{PILOT}) of those symbols received in correspondence of the known transmitted symbols and used in the calculation of the weighting coefficients is thus very important in determining the performance of the beamforming algorithm.

As a general rule, the availability of a larger number of symbols for the calculation of the weighting coefficients allows a better reduction of the impairments caused by noise and interference.

The arrangement described herein achieves a significant performance improvement by using in addition to the symbols received in correspondence of the “known” transmitted symbols, other additional symbols in the calculation of the weighting coefficients.

In the exemplary case of the W-CDMA system these additional N_{ADDITIONAL} symbols are the TPC, FBI and TFCI transmitted on the DPCCH channel.

As the additional symbols are not known at the receiver, the arrangement described herein includes a fast and reliable detection of these “unknown” symbols, introducing at the same time just a minor increase in the receiver complexity.

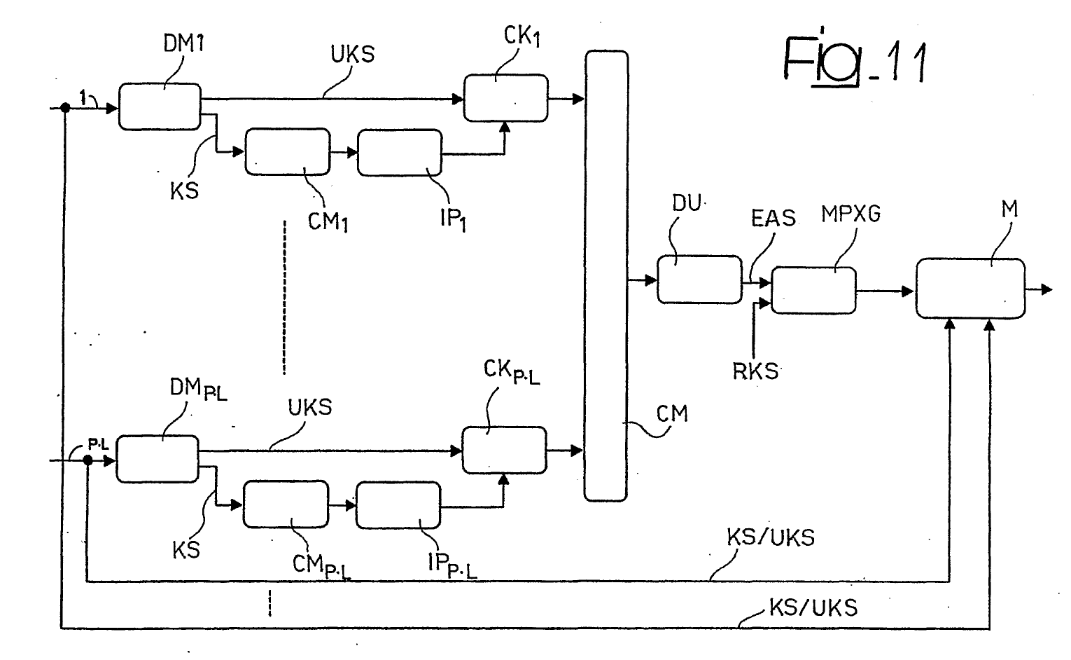

Assuming that the receiver includes P antennas (P≧2) and P receiver modules, each receiver module will comprise a front-end, which downconverts to digital baseband the RF analog signal, and a rake receiver with L fingers. The P·L rake receiver fingers will perform the despreading of the received signal replicas and the despread symbols are stored in a memory. Each finger will be associated to a replica of the received signal collected at the output of a given antenna that will be denoted, from now on, as a signal component. The despread symbols are then provided to the beamforming unit. A corresponding block diagram is shown in FIG. 11.

Operation of the arrangement described encompasses the following processing modules/steps.

Firstly, the symbols received in correspondence of the known transmitted symbols for each signal component 1, . . . , P·L are demultiplexed via respective multiplexers DM₁, . . . , DM_{P·L} in order to exploit them for channel estimation purpose.

Then, a channel estimation module CM₁, . . . , CM_{P·L} estimates the attenuation and phase shift introduced by the channel for each signal component. The attenuation and phase shift of the channel in correspondence of each “known” symbol KS is represented by a complex number C(k) denoted as channel coefficient. This processing is described in the example related to the W-CDMA system by the equation (6) and the circuit of FIG. 9.

The channel coefficients in correspondence of the additional symbols UKS are then estimated in estimation modules IP₁, . . . , IP_{P·L} by applying some kind of interpolation or prediction method, for example, as already discussed, a linear interpolator operating between the last channel estimate obtained from the pilot symbol X_{Q}(N_{PILOT}-1) of the current slot that includes the additional symbols and the first channel estimate obtained from the pilot symbol X_{Q}(0) of the following slot. In the example of the W-CDMA system the additional symbols are the TPC, TFCI and FBI bits of each slot.

Channel compensation of the received additional symbols is then effected in modules CK₁, . . . , CK_{P·L} by multiplication of the received additional symbols for the complex conjugate of the corresponding channel coefficients. This operation compensates the phase shift introduced by the channel.

The additional symbols received from the various signal components are then combined in a combiner module CM. For example a Maximum Ratio Combination (MRC) is obtained by simply summing the additional symbols corresponding to the various signal components obtained.

A decision unit DU subsequently performs a hard decision on the additional symbols UKS in order to get an estimate of the corresponding transmitted value and the estimated additional symbols EAS are then multiplexed in a multiplexer MPXG with the known symbols RKS stored at the receiver.

The symbols RKS known and the estimated additional symbols EAS are then provided as reference symbols to the unit M that performs the computation of the weighting coefficients.

This unit receives also as a second input the symbols KS received in correspondence of the known transmitted symbols together with the additional symbols UKS received from the channel for each signal component.

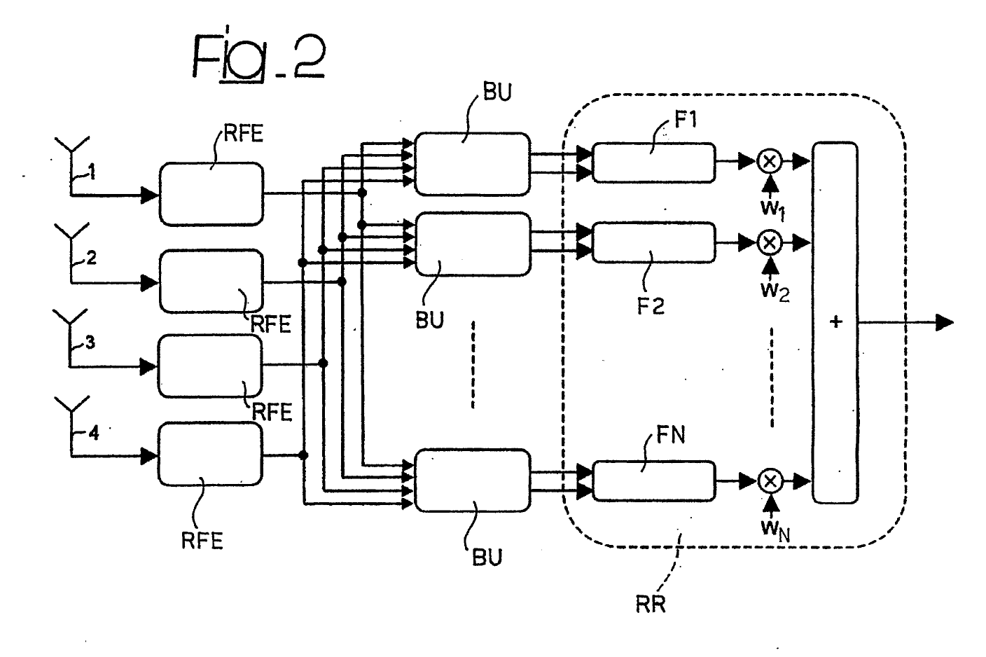

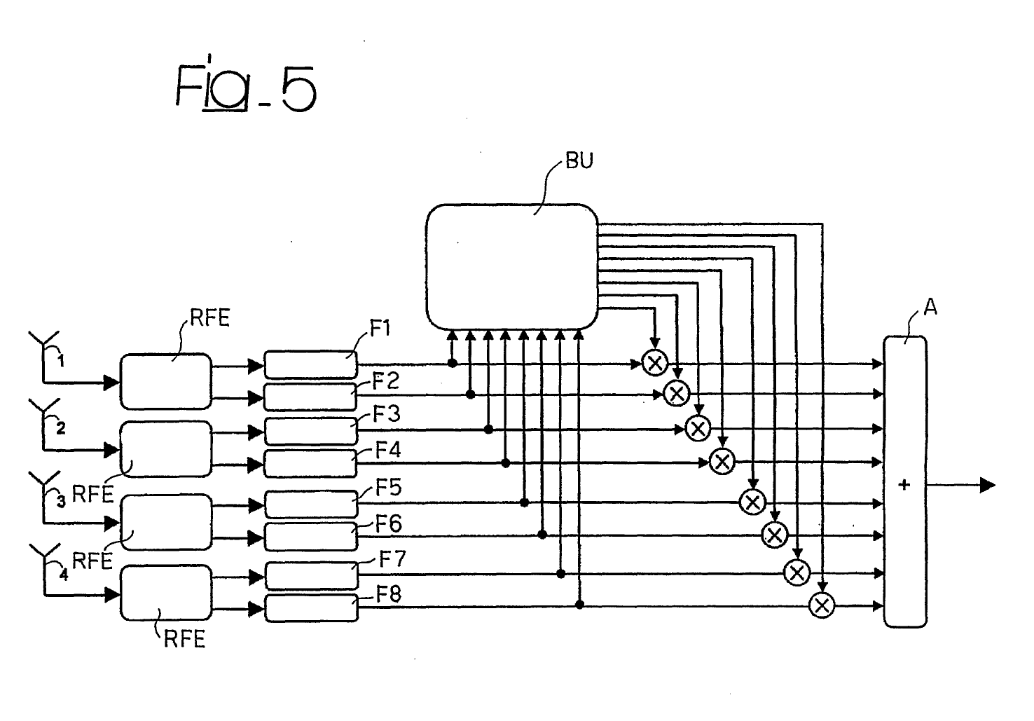

The calculated weighting coefficients are then used (in a known manner-see also the introductory portion of the description) for the combination of the signals received from the various antennas. This operation can be performed both at chip level, according to the 2D-Rake architecture of FIG. 2, or at symbol level as in the joint space-time architecture of FIG. 5.

Performance improvement obtainable with the arrangement described herein is notable. Specifically, tests were performed with a W-CDMA system by evaluating link performance in terms of Block Error Ratio (BLER) for the 64 kbit/s data service, as a function of the E_{b}/Nₒ ratio measured at the Layer 1—Layer 2 interface. As is well known, E_{b} is the average energy per information bit and Nₒ is the noise plus interference power spectral density.

The propagation channel considered was the multipath fading case 3, defined in the 3GPP specifications. The speed of the user equipment is v=120 km/h. The number of pilot bits N_{PILOT} is equal to 3, which represent the minimum value (worst case) for the slot formats used in the compressed mode procedure. Interpolation of the channel estimates was performed with a simple linear interpolator operating on two consecutive slots.

The base station receiver is composed of M=4 antennas spaced apart of half wavelength (λ\2). The beamforming algorithm used is an LMS (Least Mean Squares) without normalization. This algorithm computes the weighting coefficients in such a way that the mean square error (MSE) between the combined signal and the training sequence is minimized. The direction of arrival of the various echoes is assumed to have a Laplacian distribution with an angle spread (AS) of 5 degrees.

Specifically, the arrangement described herein was compared with prior-art receivers, employing a LMS algorithm taking into account only the known pilot symbols.

An ideal case was also considered that gives the performance bound achievable when all the DPCCH bits (pilot and other symbols) are supposed known at the receiver.

The arrangement described herein was found to offer a gain of about 1 dB in terms of E_{b}/N₀ for a target BLER of 10⁻², with respect to prior art receivers. The gain in terms of link performance can be translated into the corresponding capacity increase using a simple analytical model such as the pole equation. Using the pole equation model a capacity increase of about 23% for the 64 kbit/s data service is obtained at the price of a small additional complexity in the receiver.

Alternative embodiments of the arrangement described herein may employ different techniques for channel estimation and interpolation (or prediction) of the channel coefficients. This aspect is directly related to the complexity/performance trade-off of the proposed method with respect to prior-art schemes.

The possibility also exists, e.g. of considering different transmission standards for which the additional symbols can be data or control symbols transmitted in particular channels or using particular transmission methods.

Even when referring to the-exemplary case of W-CDMA standard other slot formats with a different number of pilot bits can be considered.

A further application of the arrangement described herein is in conjunction with a radio over fiber (ROF) system which allows the remotization, through optical fiber, of the radio frequency (RF) and intermediate frequency (IF) processing parts from the related base band (BB) processing modules. In this particular application the RF and IF modules processing the P received signals can be located near the P receiving antennas while the BB processing modules performing, among other things, the operations of channel estimation, weighting coefficients computation and signal recombination can be remotized in a different location through suitable transmission over optical fiber.

It is thus evident that, without prejudice to the underlying principles of the invention, variants and embodiments may vary, also significantly, with respect to what has been described, by way of example only, without departing from the scope of the invention as defined by the annexed claims.

1-27. (canceled)

28. A method of performing channel estimation based on a signal received after propagation over a communication channel, said received signal comprising both known and unknown symbols, comprising the steps of:
detecting said unknown symbols in said received signal by assigning estimated values to said unknown symbols;
performing said channel estimation by exploiting both said known symbols and the estimated values assigned to said unknown symbols; and
producing said received signal by using multiple receiving antennas.

29. The method of claim 28, comprising the step of producing said received signal by using diversity antennas.

30. The method of claim 28, comprising the steps of deriving, from said multiple antennas a plurality of signal components each comprised of a replica of said received signal collected at the output of one of said multiple antennas, and performing, on each said signal component, the steps of:
separating said known and said unknown symbols in each said signal component;
performing channel estimation of said known symbols in said signal component;
performing channel compensation of said unknown symbols in said signal component based on the result of said channel estimation performed on said known symbols; and
detecting said unknown symbols starting from said channel-compensated unknown symbols in said signal component.

31. The method of claim 30, comprising the step of associating with said multiple antennas respective Rake receivers, each having associated a plurality of fingers, whereby each of said fingers generates a signal component comprised of a replica of said received signal collected at the output of one of said multiple antennas.

32. The method of claim 30, wherein said channel estimation of said known symbols in said signal component has associated at least one of an interpolation and a prediction step.

33. The method of claim 30, comprising the step of combining said channel-compensated unknown symbols and assigning said estimated values thereto by means of a decision provided on said combined, channel-compensated unknown symbols.

34. The method of claim 33, wherein said step of combining is performed as maximum ratio combination of said channel-compensated unknown symbols.

35. The method of claim 28, wherein said received signal is a CDMA signal comprising known pilot bits to support a channel estimation for coherent detection, said known pilot bits comprising said known symbols and additional symbols comprising said unknown symbols, said additional symbols being selected from the group:
transmit power-control commands,
feedback information for transmitting antenna diversity, and
at least one transport-format combination indicator.

36. The method of claim 35, wherein said received signal is an uplink DPCCH signal in a W-CDMA physical channel.

37. A method of calculating weighting coefficients for beam-forming the radiation pattern of an antenna array exploiting channel estimates obtained by means of the method according to claim 28.

38. A method of receiving a signal after propagation over a communication channel, by using multiple receiving antennas comprising the steps of:
calculating weighting coefficients according to the method of claim 37; and
combining the signals received from said antennas according to previously computed weighting coefficients.

39. A method of establishing a radio communication link between a transmitting unit and a receiving unit, comprising the steps of:
transmitting over a communication channel, by means of said transmitting unit, a signal comprising both known and unknown symbols;
receiving said signal at the receiving unit by means of multiple receiving antennas;
performing estimation of the channel characteristics according to the method of claim 28;
calculating weighting coefficients based on channel characteristics previously calculated; and
combining the signals received from said antennas according to previously computed weighting coefficients.

40. A method of establishing a radio communication link, between a transmitting unit and a receiving unit where the base band modules of the receiving unit are remotized with respect to the receiving antennas by means of a radio over fiber system, comprising the steps of:
transmitting over a communication channel, by means of said transmitting unit, a signal comprising both known and unknown symbols;
receiving said signal at the receiving unit by means of multiple receiving antennas;
remotizing the signals received from the multiple receiving antennas through an optical fiber link;
performing estimation of the channel characteristics according to the method of claim 28;
calculating weighting coefficients based on channel characteristics previously calculated; and
combining the signals received from said antennas according to previously computed weighting coefficients.

41. A system for performing channel estimation based on a signal received after propagation over a communication channel, said received signal comprising both known and unknown symbols, comprising:
detector circuitry for detecting said unknown symbols in said received signal by assigning estimated values to said unknown symbols; and
channel estimator circuitry for performing said channel estimation by exploiting both said known symbols and the estimated values assigned to said unknown symbols, wherein the system has associated multiple receiving antennas for producing said received signal.

42. The system of claim 41, comprising associated diversity antennas for producing said received signal.

43. The system of claim 41, comprising receiver circuitry for deriving, from said multiple antennas a plurality of signal components each comprised of a replica of said received signal collected at the output of one of said multiple antennas, the system comprising for each said signal component:
a separator for separating said known and said unknown symbols in each said signal component;
a channel estimator for performing channel estimation of said known symbols in said signal component;
a channel compensator for performing channel compensation of said unknown symbols in said signal component based on the result of said channel estimation performed on said known symbols; and
a detector for detecting said unknown symbols starting from said channel-compensated unknown symbols in said signal component.

44. The system of claim 43, comprising associated with said multiple antennas, respective Rake receivers, each said Rake receiver comprising a plurality of fingers, whereby each said finger generates a signal component comprised of a replica of said received signal collected at the output of one of said multiple antennas.

45. The system of claim 43, wherein said channel estimator comprises at least one of an interpolator and a predictor.

46. The system of claim 43, comprising a combiner for combining said channel-compensated unknown symbols and assigning said estimated values thereto by means of a decision provided on said combined, channel-compensated unknown symbols.

47. The system of claim 43, wherein said combiner is a maximum ratio combiner of said channel-compensated unknown symbols.

48. The system of claim 41, comprising a CDMA receiver, whereby said received signal is a CDMA signal including known pilot bits to support a channel estimation for coherent detection, said known pilot bits comprising said known symbols and additional symbols, comprising said unknown symbols, said additional symbols being selected from the group of:
transmit power-control commands,
feedback information for transmitting antenna diversity, and
at least one transport-format combination indicator.

49. The system of claim 48, comprising an uplink DPCCH receiver in a W-CDMA physical channel.

50. A system for calculating weighting coefficients for beam-forming the radiation pattern of an antenna array, comprising a system for performing channel estimation according to claim 41.

51. A system for receiving a signal after propagation over a communication channel, comprising associated multiple receiving antennas, comprising:
a system for calculating weighting coefficients according to claim 50; and
a combiner for combining the signals received from said antennas according to previously computed weighting coefficients.

52. A system for establishing a radio communication link between a transmitting unit and a receiving unit, comprising:
a transmitting unit for transmitting over a communication channel a signal comprising both known and unknown symbols;
a receiving unit for receiving said signal by means of multiple receiving antennas;
a system for performing channel estimation according to claim 41;
a system for calculating weighting coefficients based on channel characteristics previously calculated; and
a combiner for combining the signals received from said antennas according to previously computed weighting coefficients.

53. A system for establishing a radio communication link between a transmitting unit and a receiving unit where the base band modules of the receiving unit are remotized with respect to the receiving antennas, comprising
a transmitting unit for transmitting over a communication channel a signal comprising both known and unknown symbols;
a receiving unit for receiving said signal by means of multiple receiving antennas;
an optical fiber link for remotizing the signals received from the multiple receiving antennas;
a system for performing channel estimation according to claim 41;
a system for calculating weighting coefficients based on channel characteristics previously calculated; and
a combiner for combining the signals received from said antennas according to previously computed weighting coefficients.

54. A computer program product, loadable in the memory of at least one computer and comprising software code portions capable of performing the method of claim 28.
